(19) United States
(12) Patent Application Publication
(10) Pub. No.: US 2025/0245481 A1
(43) Pub. Date: Jul. 31, 2025

(54) DEVICES, SYSTEMS AND METHODS FOR DETECTING LEAKS AND MEASURING USAGE

(71) Applicant: IoT Technologies LLC, La Jolla, CA (US)

(72) Inventor: Abraham GREENBOIM, La Jolla, CA (US)

(21) Appl. No.: 19/038,500

(22) Filed: Jan. 27, 2025

Related U.S. Application Data
(60) Provisional application No. 63/625,011, filed on Jan. 25, 2024.

(51) Int. Cl. G06N 3/045; G06N 3/0985

(52) U.S. Cl. CPC G06N 3/045; G06N 3/0985

(57) ABSTRACT

A system comprising: at least one hardware processor; and one or more software modules that are configured to, when executed by the at least one hardware processor, receive an input data set; perform data analysis; perform data preprocessing encode, normalize and handle any missing values in the input data set; select model hyperparameters and model architecture to develop a model; perform model training for the model; evaluate the model after training; and deploy the model in a device.

### CROSS-REFERENCE TO RELATED APPLICATIONS

The application claims priority under 35 U.S.C. § 119 (e) to U.S. Provisional Patent App. No. 63/625,011, filed on Jan. 25, 2024. This application is also related to U.S. patent application Ser. No. 17/834,916, filed on Jun. 7, 2022, and entitled “Devices, Systems and Methods for detecting Leaks and Measuring Usage,” which in turn claims priority under 35 U.S.C. § 119 (e) to U.S. Provisional Patent App. No. 63/209,240, filed on Jun. 10, 2021, U.S. Provisional Patent App. No. 63/212,568, filed on Jun. 18, 2021, U.S. Provisional Patent App. No. 63/212,573, filed on Jun. 18, 2021, to U.S. Provisional Patent App. No. 63/305,619, filed on Feb. 1, 2022, to U.S. Provisional Patent App. No. 63/307,370, filed on Feb. 7, 2022, to U.S. Provisional Patent App. No. 63/322,848, filed on Mar. 23, 2022, to U.S. Provisional Patent App. No. 63/322,960, filed on Mar. 23, 2022, and to U.S. Provisional Patent App. No. 63/322,897, filed on Mar. 23, 2022. These and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### BACKGROUND

### Field of the Invention

The embodiments described herein are generally directed to leak detection and measuring or monitoring usage, and more specifically detect leakage in pipes and presenting actionable data related thereto.

### SUMMARY

Accordingly, devices, systems, methods, and non-transitory computer-readable media for fluid (e.g., water, gas) leak detection are disclosed herein. Also disclosed herein are devices, systems, methods and non-transitory computer-readable media for monitoring and/or measuring and/or controlling fluid usage, for example, in an appliance, a unit, or a building.

According to one aspect, a system comprising: at least one hardware processor; and one or more software modules that are configured to, when executed by the at least one hardware processor, receive an input data set; perform data analysis; perform data preprocessing encode, normalize and handle any missing values in the input data set; select model hyperparameters and model architecture to develop a model; perform model training for the model; evaluate the model after training; and deploy the model in a device.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a portion of a pipe having a detector device at least partially wrapped (e.g., clamped) around a pipe section, according to an embodiment;

FIG. 4 illustrates a set of ultrasonic sensors coupled to a conduit and configured to monitor a fluid flowing through the conduit, according to an embodiment;

FIG. 5 is a bar graph showing the data distribution of training data for the experiments described herein;

FIG. 6 is a bar graph showing the data distribution of validation data for the experiments described herein;

FIG. 7 illustrates the trend for the medium leak class observed in the course of the experiments described herein;

FIG. 8 illustrates the trend for the stable class observed in the course of the experiments described herein;

FIG. 9 illustrates the trend for the small leak class observed in the course of the experiments described herein;

FIG. 10 illustrates the trend for the normal class observed in the course of the experiments described herein;

FIG. 11 illustrates the trend for the major leak class observed in the course of the experiments described herein;

FIG. 12 illustrates a model training process in accordance with one example embodiment;

FIG. 13 illustrates an example automated process of data processing and model creation in accordance with one example embodiment;

FIG. 14 illustrates an example process for data synthetic data generation in accordance with one embodiment.

### DETAILED DESCRIPTION

In an embodiment, systems, methods, and non-transitory computer-readable media are disclosed for leak detection and measuring or monitoring usage.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1 Infrastructure

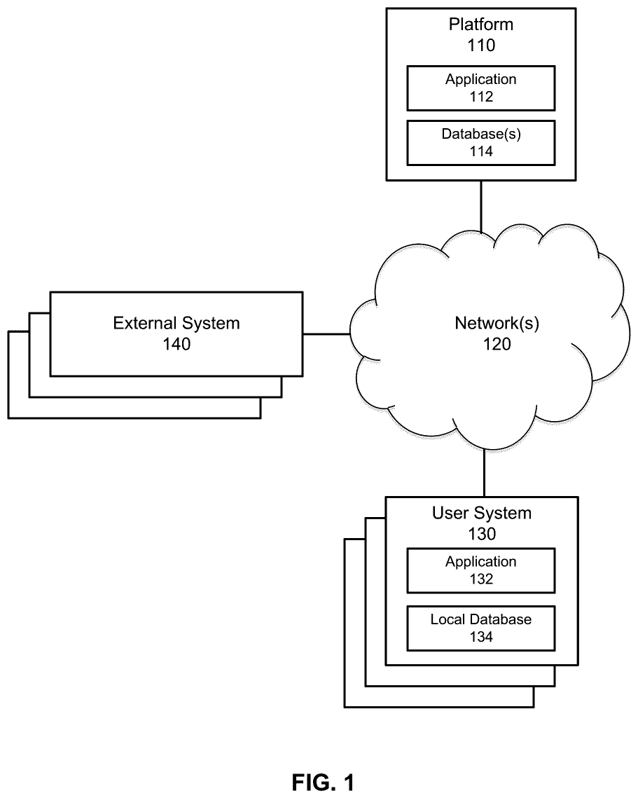

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. It should be understood that platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 1.2 Example Processing Device

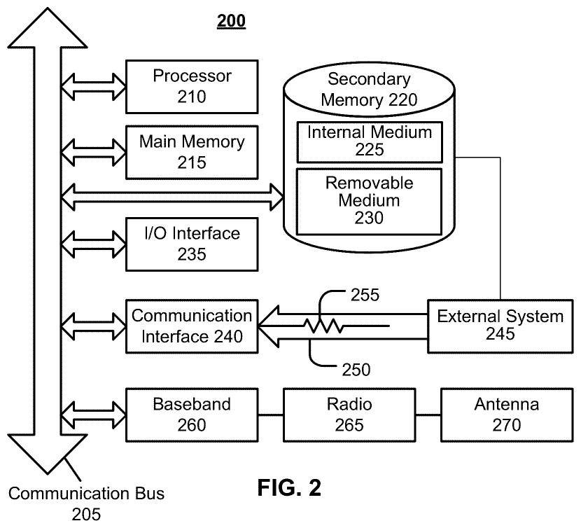

FIG. 2 is a block diagram illustrating an example wired or wireless system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

### 2. Process Overview

Embodiments of processes for leak detection and measuring or monitoring usage will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1. Leak Detection

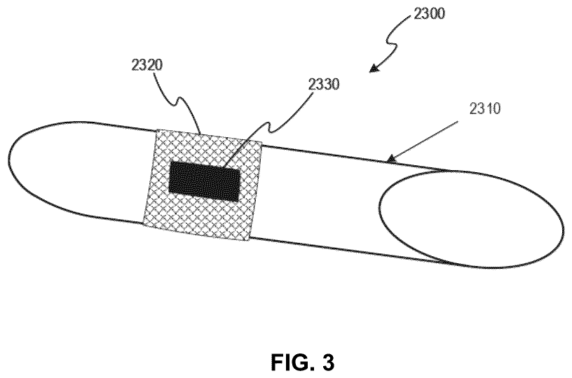

Also disclosed herein are devices, systems and methods for monitoring a fluid and/or detecting a leak in a liquid conduit, e.g., pipe, tube that comprise an, e.g., wrapped sensor or sensors, e.g., accelerometer, gyroscope, ultrasound sensors, and temperature sensors, for example, as shown in FIG. 3, which corresponds to FIG. 23 in U.S. patent application Ser. No. 17/834,916 (the '916 Application) noted above. As noted in the '916 Application, in a system 2300, a detector device 2330 can be provided, the detector device configured to be positioned at least partially around an outside of a conduit 2310, comprising at least one sensor. The device can comprise a clamp, band or other component 2320 configured to removably and/or fixedly couple to, e.g., clamp around an outside portion of a pipe, tube, or other conduit.

It should be noted, however that ultrasound implementations can increase, e.g., cost, size, power consumption, etc. Thus, certain embodiments specifically use gyroscopes and/or accelerometers to replace ultrasound sensors. The devices disclosed here can be part of, e.g., maintenance management systems enabling the detection of future issues before they arise. In addition to water pipe systems, e.g., in a building such as a house or apartment building, other use cases include liquid refrigerant in cooling systems, coffee vending machines, movement of electrical copper wires, underground liquid pipes, etc.

The systems and methods described below, allow an ML model to be created by collecting a dataset, as described below, and then training a model, e.g., in the cloud and then deploying it to the edge, i.e., the device(s). As a result, the model is trained with respect to pipe size and other deployment specific variables. Importantly, this can also provide the ability to create dynamic real-time modeling. In other words, the model can be deployed to the edge and used to predict issues that will arise, i.e., the model can see trends and patters that will indicate a leak, or blockage, or some other problem. The device or system connected thereto, can then issue warnings, alerts, alarms, etc. But moreover, the data can still be sent, e.g., into the cloud, where the original model can be updated in real-time, where the training can be updated and the model retrained. This of course, can also occur at the edge.

The can be important because as components age, pipes, valves, etc., the data will also change in ways that may result in false positives based on the model created when the components were, new or newer. This is important: as components age, the model may not detect slight variations over time. In other words, as the ML learns overtime, it will adjust to aging and the invariable loosening of tolerances that come therewith. The model may therefore not recognize the difference between aging and an impending failure. Conversely, if the model is made to be too rigid, then it may not adjust appropriately for normal aging and produce falls alarms.

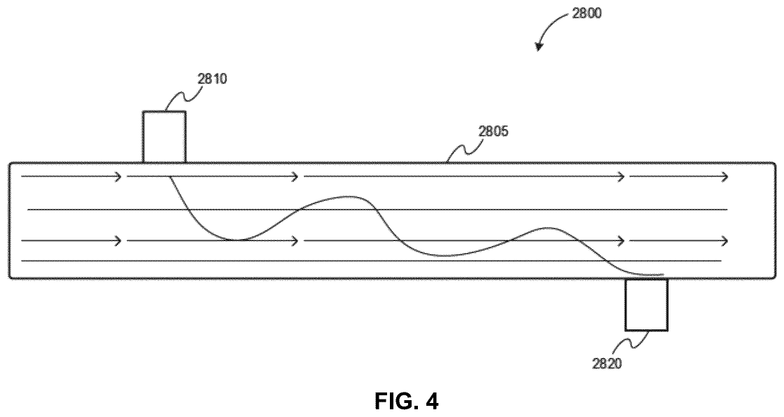

FIG. 4, which corresponds to FIG. 28 in the '916 Application, illustrates a system 2800 of the disclosure comprising a conduit 2805, a first sensor device or platform of sensors 2810 wrapped around at least a portion of the conduit at a first position, and a second sensor device or platform of sensors 2820 wrapped around at least a portion of the conduit at a second position separate from the first sensor device/platform 2810, e.g., downstream from the first sensor device/platform 2810. The sensor devices/platforms can be configured to measure a length of flow of a fluid, e.g., water, flowing through the conduit 2805. An echo incidence time delay registry code can be calibrated according to the frequency of at least one of the first sensor device/platform 2810 and the second sensor device/platform 2820. The sensor device(s) or platform(s) can comprise a driver circuit, for example, a high frequency gate controlled drive, or H-bridge driver. In some embodiments, this is necessary for the main circuit because the main circuit may not compensate for the power draw of the module. An Esp32, for example, in this regard is very sensitive to reverse spikes.

Without being bound by any particular theory, exemplary calculations using ultrasound sensors, such as those described and illustrated in FIG. 4 are provided below:

The time taken by waves to travel from point A to B is T₁, and the time taken for waves to move from B to A is T₂. T₂ is greater than T₁ because waves moving from point A to point B are assisted by the flow of water moving in the same direction. In some embodiments, speed of water can be measured at two distinct points on a pipe. The frequency can be changed with respect to speed of water. The speed of ultrasound can increase as the sound is moving in the direction of fluid. The speed of ultrasound can decrease in the opposite direction of travel of fluid. This is called transit time method of finding relative speeds.

In some aspects, T₁=L/(U+ (assistance by water)).

In some aspects, T₂=L/(U+ (resistance due to water)).

In some aspects, the assistance and resistance due to water are inversely proportional to the angle that waves make with water (cosx). After substitution the equations can become: T₁=L/(U+cosx), and T₂=L/(U-cosx).

$$Δ T = ( L / ( U - cos x ) ) + ( L / ( U + cos x ) ) .$$

$$Δ T = 2 VL cos x / ( {U}^{2} - {V}^{2} {cos}^{2} x ) .$$

### Example: Δ T when U=1497 m/s, V=1 m/s, D=100 mm (width of pipe) and x=45°

Solution: L=D/sinx=155.5/1000=0.1555 meters; T₁=L/(U+Vcos (x))=0.1555/(1497+1 cos (45))=103825 nano seconds; T₂=0.1555/(1497−1 cos (45))=103923 nano seconds; Δ T=T₂-T₁=98 nano seconds. (Δ T×(speed of ultrasound in fluid))/2=speed of fluid in pipes. The time difference between sent and received waves can be used, for example, to measure the speed of flow.

The speed of sound in water also depends on the temperature of water so necessary adjustment may be needed to eliminate the errors from calculations and a temperature sensor needs to be placed on pipe to measure real-time fluid temperature.

In some aspects, a total of 4 sensors/platform provided to be used for this setup to work. Generally, the higher the frequency of transducer the more accurate it is and more expensive the transducer. In some aspects, the recommended frequency of transducer is greater than 1 MHz and a preferred value of transducer is 10 MHz or greater with accuracy within 1%. The transducers may be operated by some source that has frequency greater than transducers frequency. So, a frequency generator can be introduced in the setup. And some power electronics to amplify the signal so the transducer receives the necessary power. Then any microcontroller board can be used to analyze the data and then represent on any given screen or output device.

Contemplated systems for detecting leaks like those described with respect to FIGS. 3 and 4, and below, can be used for submetering purposes. In office buildings, apartments, or other multi-tenant buildings, the systems described herein can be used to measure each apartment unit and/or office space's water usage, e.g., for billing purposes. This can be very important for commercial buildings like hotels, apt buildings and warehouses, which can have numerous toilets, but usually have one water meter for the building. Tenants or guests usually do not care about their water usage in such environments, but the cost of leaks can be significant. By deploying the systems and methods described herein, sensor devices/platforms can be deployed to detect fluid data, which can be reported to, e.g., platform 110 having an application 112 configured to determine usage and/or condition of fluid system of a building based on sensor data, e.g., fluid data, as described in this disclosure. It should be noted that the sensors/platforms do not necessarily need to be deployed near an appliance, such as a toilet or sink to detect leaks associated therewith, as opposed to conventional sensors and as described below.

User systems 130 can then be used to view information associated with the usage and/or condition of one or more systems/appliances within the building. Platform 110 can also be configured to alert the user(s) when the data indicates a potential leak. The sensor/platform can actually be used, in such embodiments to provide water usage per toilet, appliance, unit, space and/or owner. This is because the sensor(s) can monitor fluid flowing through various conduits throughout a building, e.g., using vibration data, pressure change data, and/or any other suitable data, for example, a toilet is flushed. For example, in a toilet a flush is something much different than a leak or evaporation and as such, the “signature” for a flush can be detected. But the fluid data due to flushing, leaks, evaporation, etc., for each unit can be detected and, for example, displayed and/or provided to a user system of a building manager or other entity, e.g., via a user system 130. In some aspects, the system can measure usage by getting fluid data and additional data associated with the fluid system, e.g., the size of a toilet tank or pool of a fluid system. A length of time of a flush refill can indicate usage. A small leak might be continuous and prevent a refill of the tank until the leak is fixed. Viewed from another perspective, a normal activity, which can be a flush refill, times the size of the tank, times the number of uses, can indicate a use. A continuous small leak (or a major leak), for example, can prevent the tank from refill and continue water stream until it is fixed. Such a leak can be detected and determined to be indicative of an abnormal event, e.g., a small leak.

Thus, the systems described herein can comprise, e.g., in platform 110, and/or a user system 130, algorithms and processes that allow the system to recognize a leak based on the patterns, signature, and/or timing of flow, and/or measure usage based on sensor data. Moreover, the system can learn over time to predict leaks, or worsening leaks, as well as inefficient water usage generally.

It is contemplated that the systems described herein can be positioned around and/or adjacent any suitable conduit of a fluid system where fluid passes, e.g., drain pipe, any suitable portion of a breast pump through which fluid flows, any suitable portion of a milking machine through which fluid flows, and/or in or adjacent a container of a fluid system.

In some aspects, a system can comprise multiple sensor devices each comprising at least one sensor configured to obtain sensor data as described herein, the sensor data being associated with a second fluid flowing through various fluid systems. Each sensor device can comprise at least one, or at least a portion of a processor system 200 configured to perform instructions, the instruction configured to cause the at least one processor to transmit sensor data, via a communication interface, to the platform 110. Viewed from another perspective, the systems described herein can comprise a second, third, fourth, fifth, or any suitable number of sensor devices or platforms as described. For example, sensor devices/platforms can be installed around numerous conduits and/or containers in a home, building, etc. through which fluid flows, and transmit sensor data to a platform. The platform 110 can comprise and/or be coupled to one or more databases storing evaluation data, and can comprise an application storing software instructions that upon execution cause the application to determine usage and/or condition of one or more of the fluid systems of the system based at least in part on sensor data obtained from one or more sensor devices/platforms deployed in one or more fluid systems.

A way to detect any flow of liquids in multiple appliances such as showers, faucets, dish washer, outside hose, and even to other applications like sub metering multi-unit apartments, measuring flow of milk from cows, determine amount of milk coming out during breast feeds or breast pumps, and various other applications, including industrial applications, are contemplated herein.

In some aspects, once a leak is detected, the system can automatically cause an on/off or partial close, e.g., of a pipe valve, function to be performed. In some aspects, a detector, and/or other components described herein, can be connected to a toilet, faucet, beverage machine, or other appliance, and the system, or an operator using the system, can schedule a maintenance service and/or determine a charge based on usage and/or cause supplies to be ordered, e.g., filters, pods, etc., based on use and/or a subscription and/or be presented with options, via a user interface, to schedule a service, order supplies, and/or send out a bill based on a charge, among other things.

In some aspects, the above can be done in mesh networks that has a custom hub and repeaters as needed to RF sensors installed in each device. In some aspects, components can be connected to a WiFi, cellular or other network. In some aspects, the RF sensors can utilize WiFi, cellular, LoRa, Zigbee, Z Wave, and/or other suitable technologies. In some aspects, the RF sensors are custom made.

In some aspects, one or more of the sensor devices/platforms can be configured to be positioned at least partially around an outside of a conduit or other structure of a fluid system, and the sensor devices can comprise at least one sensor, e.g., an accelerometer, an ultrasonic sensor, a gyroscope, temperature sensor, etc. The devices/platforms can be positioned around the conduit via a clamp, band or other component configured to removably and/or fixedly couple to an outside portion of a pipe, tube, or other conduit, and/or any other suitable portion of a conduit and/or appliance. In some aspects, a second sensor device/platform can be provided at least partially around an outside of the same conduit, for example, downstream of a first sensor device/platform.

One or more sensors of the sensor device can be configured to obtain sensor data associated with at least one of a vibration, a pressure change and/or length of time associated with a fluid flowing through the conduit. In some aspects, at least one processor configured to perform instructions can be provided, the instructions configured to cause the at least one processor to, among other things, receive sensor data from one or more detector devices, and at least one of transmit data associated with the sensor data (e.g., the sensor data), via a communication interface, to the platform. In some aspects, the platform can be configured to determine usage and/or condition information of a fluid system based at least in part on the sensor data. In some aspects, the platform can be configured to determine usage and/or condition information of the fluid system based at least in part on the sensor data and evaluation data stored in one or more databases.

For example, in one embodiments, it is contemplated that the devices and systems described herein can be used to detect leaks in swimming pools by wrapping one or more of the intake and outtake pipes.

In an embodiment, systems, methods, and non-transitory computer-readable media disclosed herein can detect leaks based at least in part on sensor data obtained from at least one sensor positioned outside of a conduit that a fluid flows through. As shown in FIG. 3, at least one sensor 2330 can be held in place in a position outside of a portion of the conduit 2310 via a clamp, ring, straps, or any other suitable component 2320. In some aspects, the sensor(s) 2310 can be configured such that they, or data therefrom can transmit data to a platform 110 where the data can be viewed, used to query a database to determine if there is a leak, and/or transmitted to a user system, i.e., a smartphone, application for viewing. In some aspects, the platform can be configured to alert a user system when a leak is detected.

Using, e.g., the wrapped sensor device/platform 2310 as described herein, it is contemplated that the system can measure vibration of the pipe and therefore derive the pressure fluctuation, or flow inside the pipe. By using the knowledge of pressure changes in the pipe or other conduit, the amount of flow of a fluid within the conduit can be determined. When the flow increases or decreases, fluid usage can be determined, for example, using machine learning algorithms as described below. This determination can be used to detect normal and/or abnormal behavior of a toilet, faucet, shower, hose, or other appliance.

Without being bound by any particular theory, the following principal can be used in connection with some wrapped sensor (e.g., accelerometer) devices described herein. The pipe acceleration/vibration can be measured as the second derivative over time (t)=−C*p′ (x), wherein p′ (x) is pressure fluctuation, and C is a constant.

### 2.2. Data Processing and Training

Nowadays, leaks such as toilet leakage is a major problem. Toilet leaks lead to several problems like water waste and damage to the water container. The devices, systems and methods advantageously provide a leakage detection solution. In the examples discussed herein, the device/platform can include a ESP32 with ADXL 345 containing SD card, RTC, buck boost, and mini-USB. AAA batteries are used, and rechargeable battery, e.g., lithium polymer (LiPo), can be used. The device/platform can comprise a sensor or sensors that provide fluid data that can be used in a machine learning pipeline to flawlessly categorize temporal events e.g., normal water flow, stable water movements, major, medium, or small/minor leaks, from a variety of downstream sources, e.g., appliances such as a toilet.

The problem to be solved can be viewed as a classification problem as, e.g., the platform can continuously get data from the sensor(s) during a specific interval, for example, 10 atomic readings of the sensor in 1 second (10 Hz frequency). At least some of the sensor data can be based on three-dimension data (x-axis, y-axis, z-axis) that reflects movement of the device/platform. Through these values the devices and systems of the disclosure are configured to detect if there is a leak (major, medium, small) or no leak (normal and stable).

This section explores statistical properties of the fluid data and provides insights about how it the data can be divided into training and validation sets. To build a reliable machine learning model, datasets can be divided into a training set and validation set. Training data is the set of data that is used to train and make the model learn features/patterns in the data. The training data can be fed to the neural network repeatedly, and the model can continue to learn the features of the data. The validation set is a set of data, separate from the training set, that is used to validate the model performance during training. The validation process gives information that helps determine whether the training is moving in the right direction or not. The model is generally trained on the training set, and simultaneously, the model evaluation is performed on the validation set, e.g., after each epoch. The data shows that, e.g., accelerometer data can be gathered and used for leak detection in accordance with contemplated systems not only in toilets but also in several other applications in other verticals such as agriculture, health and wellness, and various other areas.

Here, time series data of five classes that are major leaks, medium leaks, small (minor) leaks, normal, or stable, and explored. One file is considered as an atomic activity or one sample point for model training or validation. So, it is important to analyze and understand how much data exists for each class. As this is a time series problem, validation files are placed in another folder. In this example, random splitting was not used because it can place data samples from a same file into two sets. In the validation set, we keep nearly equal distribution for each class.

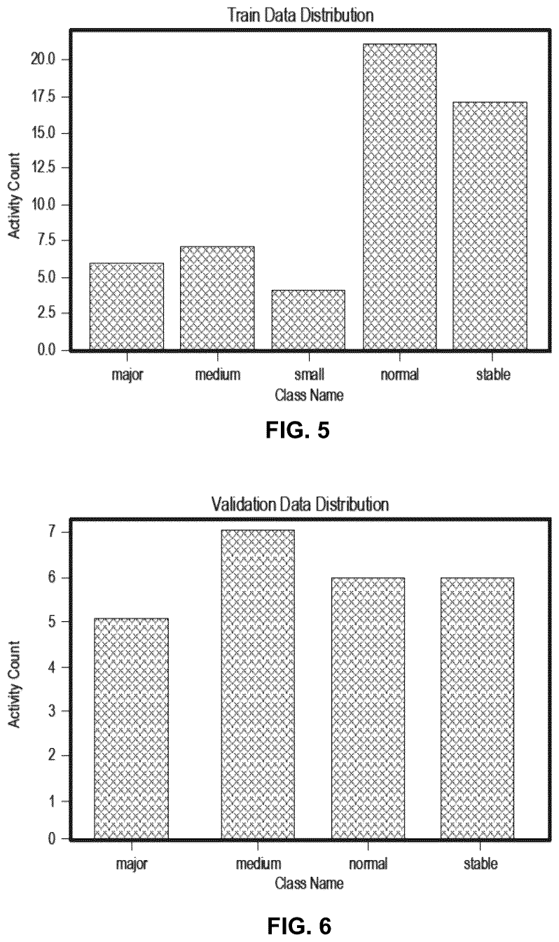

The data distribution of training data was analyzed, which is shown in FIG. 5, which corresponds to FIG. 4 in the '916 Application, and the data distribution of validation data was analyzed, which is shown in FIG. 6, which corresponds to FIG. 5 in the '916 Application. Small leaks are not included in the validation dataset given the low number of examples in this class.

### 2.2.1 Exploratory Data Analysis

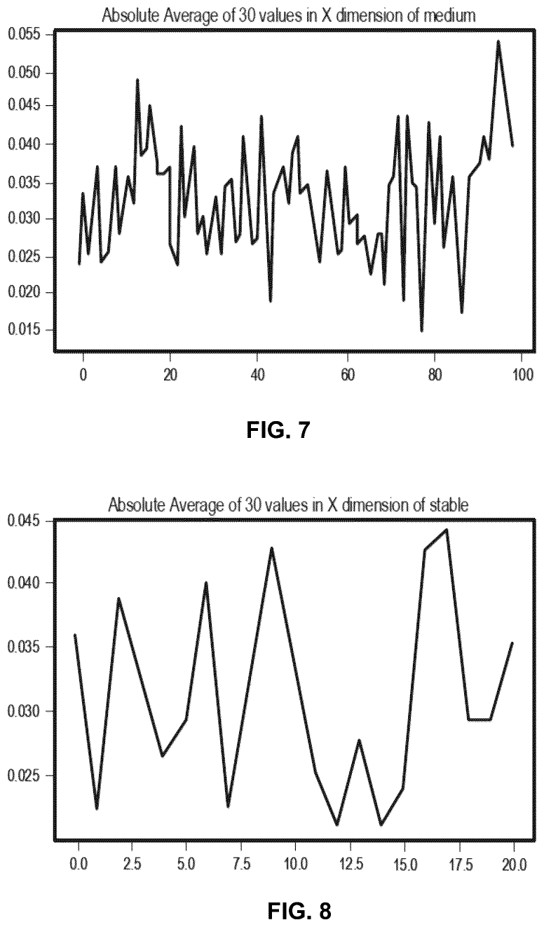

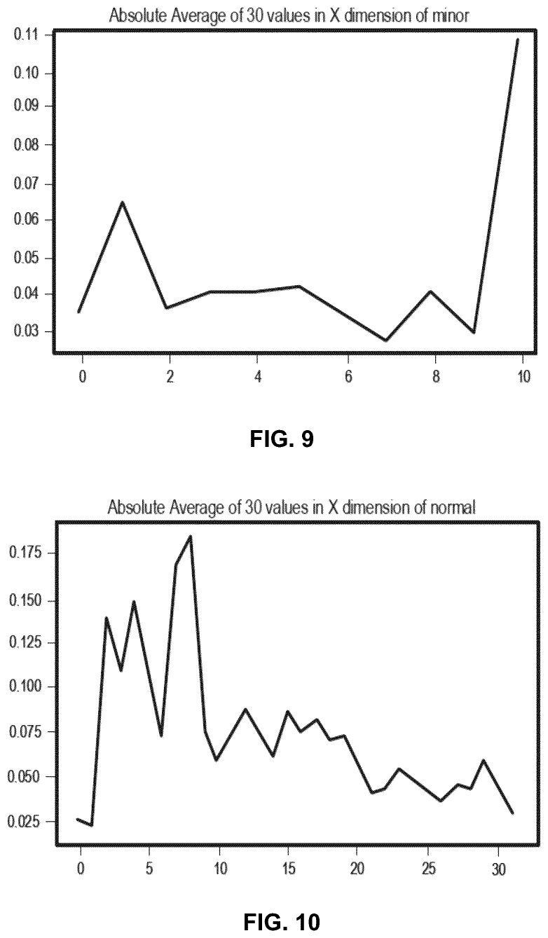

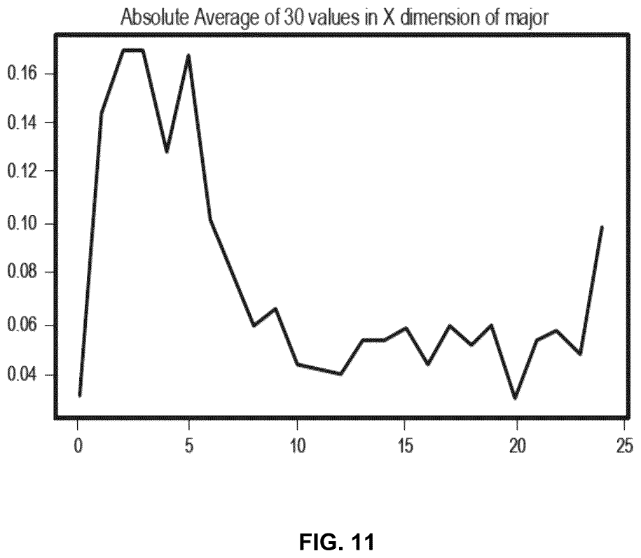

In this section, how data values change in their chronological order is explored. Not just absolute values observed, but the values are normalize such that only movement of the device/platform relative to its initial position are observed. This methodology is referred to as absolute average, as the values are simply the average of window with a size of 30 slid over the data in chronological order. The trend for the medium leak class is shown in FIG. 7, the stable class in FIG. 8, the small leak class in FIG. 9, the normal class in FIG. 10, and the major leak class in FIG. 11, which correspond to FIGS. 6-10 in the '619 Application.

### 2.2.1. (a) Application Architecture

The application comprises three major modules: IoT devices, Firebase and/or other platform for creating mobile and web applications, and user interface.

IoT Devices: Multiple IoT devices can be are placed in different locations and can be used for multiple purposes. A major purpose of the IoT devices is to detect if there is a water leak or not. Another purpose is for data gathering. The data gathered is used for machine learning model training. All the IoT devices can be connected to the Firebase.

Firebase: Firebase is a mobile application development platform (but any suitable mobile application development platforms are contemplated herein, such as Appwrite) that helps build, improve, and grow your app. Traditional app development typically involves writing both frontend and backend software. The frontend code just invokes API endpoints exposed by the backend, and the backend code actually does the work. However, with Firebase products, the traditional backend is bypassed, putting the work into the client. Firebase provides multiple features including cloud function, no need to run and maintain your own server, you do have an isolated code base for back-end code, highly scalable, real-time database that is cloud-hosted in which data is stored as JSON, the data can be synchronized in real-time to every connected client such that all of the clients share one real time database instance and automatically receive updates with the newest data, so if there is a change in any device configuration it can automatically reflect in UI, and hosting, e.g., host web application o cloud, cloud hosting for deploying angular application.

User Interface: User interface modules can contain the dashboard development. The dashboard can contain a complete user and device registration process. The dashboard can also contain data gathering functionality.

### 2.2.1. (b) Data Gathering

The Esp32 module can be connected to an Adx1343 triple-axis accelerometer with a broad sensitivity range. It can detect various kinds of motions like single tap, double-tap, activity, inactivity, and free-fall. In order to detect these different kinds of motions, the interrupts can be enabled and mapped.

Firebase can be used to store the data. The Esp32 module can connect to the Firebase Realtime Database. The Firebase Realtime Database is a cloud hosted database that allows syncing and storing data between users in real time, and it is available even when our app goes offline. A single instance of the database can be shared amongst all of our clients.

For authentication, the anonymous method can be used. Every time a user connects, the user is added to the users table.

Using the Firebase Realtime Database, a variable can be used such that whenever a change in the value of that variable occurs, it can be detected and monitored. Using the listener class, values for start and stop can be obtained.

Whenever start is selected in the app., the Esp32 module will get the value for the start flag. Get the data using the Adx1343 accelerometer in normal state for 2 minutes, stop and send the data.

In order to send the data, the values will be added to a string. Then the string will be added to a JSON object which will be sent to the Firebase Realtime Database.

Then this step will repeat for medium, stable, major, and small leaks.

### 2.2.1. (c) Data Validation

For the data validation, data had been collected in different states. That data was used for validation, Then, the predicted and actual states were matched.

### 2.2.1. (d) Interrupts

The Adx1343 is a triple-axis accelerometer that generates values for the x-axis, y-axis, and z-axis. It has a broad sensitivity range. The Adx1343 can then be used to detect various types of motions such as free fall, single tap, double-tap, or any other activity.

In order to detect these different kinds of motions, the Sparkfun_Adx1345 library. The Adx1343 can be used, which is similar to Adxl 345, so the Sparkfun_Adx1345 works well with the Adx1343. Interrupts on any of the three-axis can be detected. What kind of motion or on which axis to detect that interrupt can be customised. The threshold values for interrupts can be changed and set through experimentation.

### 2.2.1. (e) Usage in ESP32

Initially, the device/platform can be kept in sleep mode to save battery, and when any movement activity happens it can be configured to turn on. Optimal threshold for directional movements can be identified by analyzing simulated experiments. Then the Adxl can start generating data for a fixed duration which can be determined through experimentation. Data can be collected for a certain amount of time before any predictions are made. The data can then be preprocessed and the model will make predictions about which type of leak occurred. device/platform can be set to sleep mode again.

### 2.2.1. (f) Machine Learning

Preprocessing: In order to perform preprocess of the data, a preprocessing module can be built that takes data, remove anomalies (super high variations or noise), adds new features generated by weighted directional and temporal averaging of accelerometer readings, and exports them as input data for training and inference.

Model Development: A vectorized version of Support Vector Machines (SVM) with polynomial kernel can be used to perform the task of multi-class leakage classification. A grid search can be used to find optimal trade-off between the speed and performance. This model works within an atomic matrix operation and polynomial kernel operation but as there is no LAPACK support available in ESP32, the underlying algorithm may not be vectorized.

Micromlgen, a python library which ports python code into a lightweight code in C language that works off-the-shelf in ESP32 can be used. Sklearn library can be used to build and train SVM model to detect water leakage type. Then the model can be ported into C using micromlgen. This produces a header file containing our SVM model code which can be imported into a main file to predict the type of water leakage. Machine learning solutions are described in more detail in the following section.

### 2.3. Machine Learning

As noted above leakage in pipes is a complex multi-environment scenario with complex variating deployment scenarios. Thus, thus the systems and methods described herein provide a fully generalizable system focused on leakage detection in variating environments. This includes variation in fluid such as water, dense fluids such as oil, gas and more. This also includes variation in sensor environment, pipe diameters, and variation in internal and external environment. Such large scale variations also occur due to multiple deployment setups including human error. Normally, when a Machine Learning pipeline is design, it caters data handling such as data loading, data pre-processing, model training and deployment. But for each type of major condition in the scenario, the pipeline varies. This includes variation in preprocessing steps, model architecture including model hyperparameters. For different conditions of data, this pipeline would need to be changed manually, which is a slow and hectic process.

Thus, the systems and methods described herein automate this complete pipeline including data preprocessing, real time model generation including automated hyperparameter optimization. Initially a basic backbone pipeline architecture including basic model architecture is defined and automated parameters are mapped on top of this backbone. For automation of Machine Learning workflows, the concept of AutoML i.e. Automated Machine Learning, can be employed. AutoML is a technology that empowers organizations and individuals to streamline the often complex and time-consuming process of developing machine learning models. AutoML systems use sophisticated algorithms and automation techniques to automate various stages of the machine learning workflow, from data preprocessing and feature engineering to model selection and hyperparameter tuning.

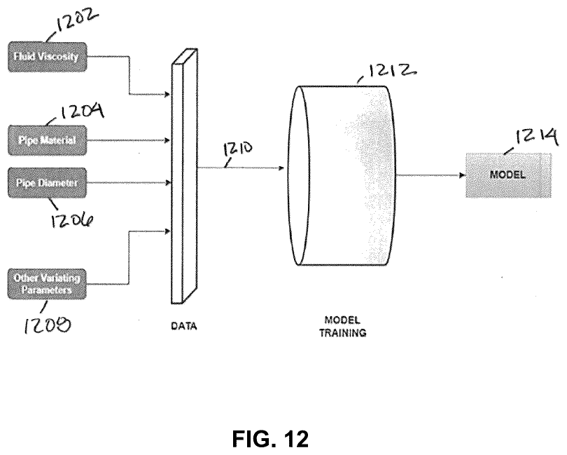

The leak detection use case described herein, faces different challenging scenarios such as the effect of different liquids’ intrinsic parameters on modeling output, and effect of different setup environments. The effect of these parameters can be handled by collecting data in a way that captures all these variating parameters. Data distribution, if generalized, would allow the automated model generation algorithm to perform learning over all these scenarios. The algorithm performs real-time model generation by considering it as an optimization problem and optimizes to the defined objective, which could be for example validation accuracy. Thus, if the data distribution is generalized, the better it is generalized, the better the model will be able to learn. As illustrated in FIG. 12, the various parameters or variables such as fluid viscosity 1202, pipe material 1204, pipe diameter 1206, and other variables 1208, can be used as input 1210 to train (process 1212) the model 1214. If data related to all such variables is captured during collection/generation, then the performance of model 1214 in a production environment would be enhanced over the scale of generalization.

Often, automating Machine Learning workflows using AutoML seems promising but requires substantial planning based execution. There are various AutoML platforms offering vast scale of functionality to automated ML workflows. There, exists different levels of abstraction to hide the implementation details from the developer. Higher level of abstraction comes with ease of development, but reduces the customization flexibility. Higher abstraction levels also lead to exponentially increasing time complexity, as AutoML platforms solve the optimization problem based on expiration and exploitation in a general term. Thus, the higher the abstraction level, the larger the search space needed for optimization. Thus, automating the workflow requires a balanced tradeoff between level of abstraction and rest of the terms on the other side.

There are multiple platforms offering AutoML sources, some of them are open source and some are proprietary. These include Auto-SKLearn, a mechanized machine-learning software package that is based on scikit-learn; MLBox, a robust Python package for automated machine learning; H2OautoML; Azure AutoML; AWS Auto Gluon; Google AutoML Cloud; and Auto-Keras.

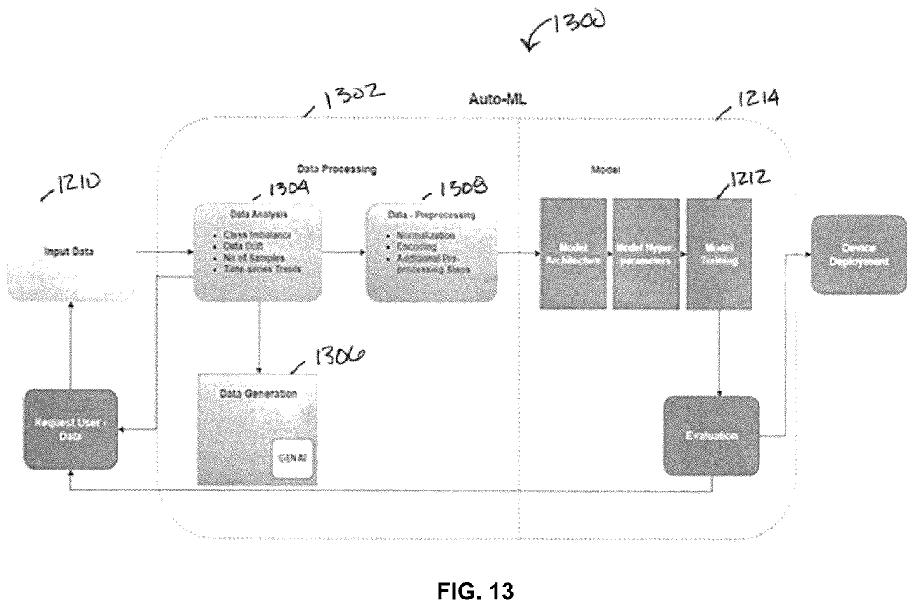

As illustrated in FIG. 13, AutoML can be used to automate the process of data processing and model creation as data 1210 gets input to the system 1300, which can, e.g., run on platform 110, and the model 1214 can be automated using, e.g., AutoKeras. In the following sections details are provided for this data processing and model creation.

### 2.3.1. Data Processing

The performance of a system 1300 configured in accordance with the systems and methods described herein will be highly optimized by the system's data centric approach. As the problem is a multivariate time series problem, the data contains interesting and useful time-series specific trends in addition to core properties of data, that will contribute to the predictions.

As the data 1210 gets input to the system 1300, a data processing block 1302 will process it. Data processing block 1302 can comprise three modules i.e., data analysis 1304, data generation 1306 and data preprocessing 1308. As the data is specific to this problem, the preprocessing steps will be kept definite.

1) Data Analysis Module 1304: In this module, various properties of time series data can be extracted. Class imbalance in the data 1210 can be checked, so if there exists an imbalance problem, it can be solved by generating data from the data generation module 1306. Class imbalance refers to when there is a significant mismatch between the number of samples of different classes. Class imbalance negatively effects the learning capability of the model 1214 during the training process 1212. Class imbalance can be solved by generating a portion of the data for the class for which there is a mismatch in the data samples. Further analysis of data 1210 will also be performed, in addition the statistical properties, time series patterns and trends of data can also be extracted.

For example, if the number of data samples is less than a certain threshold for a certain class, more data can be generated via the data generation module 1306. As this synthetic data will be generated iteratively, there may be a case of data drift. In other words as synthetic data is generated on top of base data 1210, there is significant chance of data drift which diminishes the generalization capability of the model 1214 in a production environment. Thus, as synthetic data is generated, this drift should be tested for and detected.

2) Data Generation 1306: This module will handle synthetic data generation, in case there is any call for synthetic data generation as explained above. Data generation module 1306 can employ Generative AI techniques to generate synthetic multivariate time series data based on available data. Data analysis module 1304 can be configured to request synthetic data generation when there is any class imbalance or data amount issue detected by data analysis module 1304.

Overall, this model 1214 will be integrated into the main workflow of the system 1300. As the system 1300 will be deployed in various conditions, and real time model generation will be performed, any performance issue in the model 1214 due to less data will be dealt by generating more data through this module 1306. Basic preprocessing in module 1308 can be performed on the collected data to train this architecture.

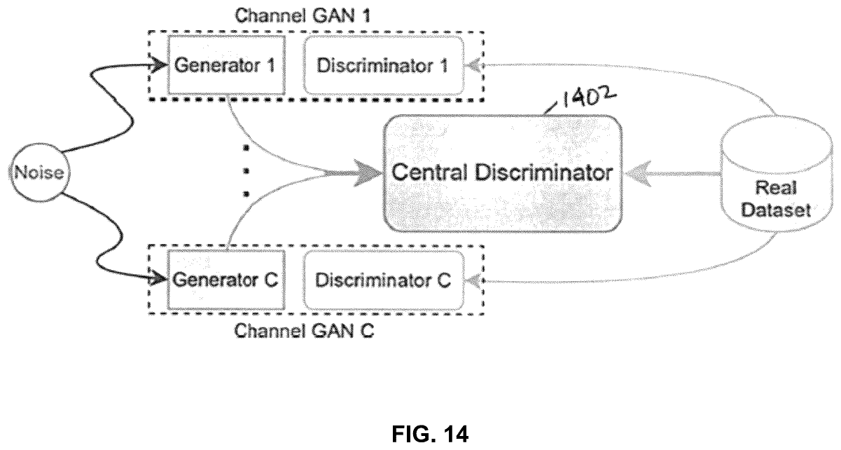

FIG. 14 illustrates an example process for data synthetic data generation that can be carried out by module 1306. This approach is specifically designed for multivariate time series data generation. COmmon Source CoordInated GAN (COSCI-GAN) can be used in this process that uses a plurality of GAN channels, e.g., 1-C.

This version of GAN is focused on handling the multivariate part in synthetic multivariate time series data generation and outperforms previous versions such as TimeGAN by statistical evaluation and also outperforms standard respective benchmarks.

Single source, multiple time series, leads to complex dynamical patterns between individual time series that are hard to learn by typical generation models such as GANs. COSCI-GAN is focused on preserving these complex dynamic relationships between different channels 1-C originating from common source i.e. sensor in our case.

It has two main parts:

1) Channel GANs 1-C, which contain pairs of generator-discriminator dedicated to a single channel (univariate TS).

2) the Central Discriminator 1402, dedicated to all channels 1-C at once. Each of these parts is responsible for a specific task.

In channel GANs 1-C, the generators 1-C are responsible for producing realistic TS and the discriminators 1-C are responsible for distinguishing between real and synthetic TS. The central discriminator 1402 is responsible for enforcing that all the generated TS of a given instance have the same correlation as those from real MTS.

Separate generators to learn the marginal distribution of each channel 1-C, separately, and then use a central discriminator 1402 to force preserving the real correlation between the channels 1-C by focusing on the conditional distributions

This architecture can be trained on collected datasets. Basic data preprocessing will be applied on the collected data and data will be converted from raw text files to csv format. Data from all files read and to be combined in a single csv file and data for classes 0, 50 and 100% will be separated respectively. Data for class 0 will be taken and samples will be created of sample length 100 and step size 5. Created samples to be horizontally stacked.

3) Data Preprocessing 1308: This part will be the data preprocessing pipeline. The necessary preprocessing transformations will be applied on the data 1210 in this module 1308, such as encoding, normalization and handling any missing values. Any model specific preprocessing will also be performed by this module 1308. Since the use case is specific, the data pre-processing steps can be set in a definite order thus not stating it as a hyperparameter. An option to set preprocessing steps as a hyperparameter and pass a search space, can be available, but that property holds for more abstract use cases, and it increases the time complexity of the optimization process significantly. Thus, there will be steps in an order that will act as a pipeline, thus data will be passed through this pipeline, fed into real-time modeling module 1214 and following. This module will ensure that the data is ready to be fed into the mode 1214.

### Model 1214:

As the data is prepared by the Data Processing block 1302, the next block to be automated is the model 1214. This block includes automating the model architecture part 1310, selection of best hyperparameters 1312, and training model 1314 on top of best architecture and hyperparameters. This search space comprises of number of layers, number of units in each layer, learning rate, and optimizer. The search space can be customizable. The core module will be evaluation module, based on evaluation results, the automated engine will decide whether to deploy the model on device or request for more data. If more data is requested, the flow will start as feedback loop from data input. The complete process starting from data input to the output model to be deployed will be automated via AutoML.

AutoKeras can be used for the real-time model generation, which can include automating the process of model training and hyperparameter tuning. AutoKeras provides us with different options to set the base configuration of model automation. The “AutoModel” class in AutoKeras allows the setting of the base configuration of this automation process, which includes, input node, output node, number of maximum trials, tuner, and objective. Objective refers to the optimization objective such as validation accuracy. Tuner refers to a component or algorithm responsible for searching through a predefined search space of hyperparameters to find the optimal combination that results in the best performance. A hyperband tuner can be selected that uses a combination of random search and early stopping to efficiently allocate resources to different hyperparameter configurations.

Autokeras provides us great level of abstraction but that comes with less customization flexibility. In our use case, we would need high level of customization flexibility to keep a balance between best model performance and optimization time complexity. Thus, we will utilize a feature provided by AutoKeras known as customized block. a customized block can be defined to define a base architecture, and set the search space. By using customized block, we have the flexibility to add custom layer types, custom model architectures, and sequential pipeline. By defining a customized block, the option can be provided to set the hyperparameters search space such as number of layers, number of units in each layer, list of activation functions, different learning rates, and optimizers. AutoKeras calls Keras Autotuner to perform hyperparameter space optimization. Restricting the search space helps shape the automation solution to a specific use case, thus reducing the time to optimize, which will support real-time model generation. After optimization, the “AutoModel” class provides a function to export best model, which can be stored in a model variable.

In order to introduce callbacks in the AutoKeras automated training process, AutoKeras does not provides a direct method of doing it. Thus, the official AutoKeras code base “graph.py” file can be modified. This file provides any/all options to customize and set a search space for compile time configuration such as introducing callbacks. Schedulers can be added as a hyperparameter using these callbacks in this file. As the official code base is modified of AutoKeras, AutoKeras can be installed from source with -e flag, ‘-e’ flag ensures that once the package i.e. AutoKeras is installed, then any change in the codebase of AutoKeras will be reflected in realtime without needing to reinstall the package each type any change is made.

For each trial in the total number of trials set in AutoModel constructor, the algorithm tries different hyperparameter configurations to get the best performance against the optimization objective. For each trial, the train configuration slongeith model checks points are saved in a separate folder.

Realtime Modeling on a Sample Data Sample Dataset: Human Activity Recognition with Smartphones-Kaggle.

In order to validate the concept of Machine Learning workflow via AutoML-AutoKeras, the ML workflow of data preprocessing, real time model generation, and hyperparameter optimization using AutoKeras can be automated. Initially developed a pipeline for preprocessing of data. This includes categorical to numerical, feature engineering, and data scaling. For model generation, we defined a custom Keras Tuner block. The base model type can be set to LSTM, and defined the search space for automated hyperparameter tuning. Hyperparameters include, number of layers, number of units in each respective layer, learning rate, choice of schedulers.

### Deployment:

This use case refers to the requirement of deployment of Machine Learning Pipeline rather than the deployment of the model serving user requests. The use case requires that after data processing, model generation and training, and best model export, the model should be installed on a device. Thus, the model will be deployed on the edge. There exists numerous options for the deployment of model, but rare options exist for roust deployment of complete Machine Learning workflow (pipeline), whether on server or on cloud. We studied, that Cloud offers more options and facilities for the efficient deployment of our Machine Learning pipeline. Microsoft Deploying a complete machine learning (ML) pipeline on the cloud can offer several advantages over deploying it on a traditional server or on-premises infrastructure. Here are some reasons why using the cloud for ML deployments can be a better idea:

Scalability: Cloud platforms provide the ability to easily scale your infrastructure up or down based on the demands of your ML workload. This is particularly important in ML, where training and inference workloads can vary significantly in terms of resource requirements. Cloud providers offer auto-scaling features that can automatically allocate more computing resources as needed, ensuring optimal performance without the need for manual intervention.

Cost Efficiency: Cloud services often follow a pay-as-you-go model, allowing you to only pay for the resources you use. This can be more cost-effective than investing in and maintaining your own on-premises hardware, which may be underutilized or become obsolete over time. Additionally, cloud providers offer various pricing options and discounts for long-term commitments, helping you optimize costs.

Elasticity: Cloud platforms enable you to provision resources on-demand, which means you can quickly adapt to changes in your ML workload. If you need to train a large model or handle a sudden influx of inference requests, you can easily allocate additional resources. Conversely, you can scale down during periods of lower demand, which can result in significant cost savings.

Managed Services: Cloud providers offer a wide range of managed ML services, such as Amazon SageMaker, Google Cloud AI Platform, and Azure Machine Learning. These services simplify the deployment and management of ML pipelines by providing pre-configured environments, version control, and automated scaling. They also offer integrated tools for data preprocessing, model training, and deployment.

Redundancy and Reliability: Cloud providers invest heavily in infrastructure redundancy and disaster recovery mechanisms. This means that the ML pipeline can benefit from high availability and data backup solutions without the need for significant upfront investment or manual setup.

Security and Compliance: Cloud providers offer robust security features and compliance certifications, which can simplify the process of securing ML pipeline. They also provide tools for encryption, access control, and auditing to help you meet regulatory requirements.

Collaboration and Integration: Cloud platforms often offer a wide range of services for data storage, processing, and analysis, making it easier to integrate ML pipeline with other data-related workflows. Collaboration among team members is also streamlined through cloud-based development and deployment environments.

Continuous Updates and Maintenance: Cloud providers handle the underlying infrastructure, including hardware maintenance, security updates, and software patches. This allows data scientists and ML engineers to focus more on model development and less on infrastructure management.

Monitoring and Logging: Cloud platforms offer extensive monitoring and logging capabilities, allowing you to track the performance and health of the ML pipeline. We can set up alerts for anomalies, monitor resource utilization, and gain insights into the behavior.

Microsoft Azure Machine Learning: is ML as a service, that offers great experience when working with on-the-cloud ML. It offers Integrated Ecosystem: Azure provides a comprehensive ecosystem for ML, with services and tools designed to support the entire ML lifecycle, from data preparation to model deployment and monitoring. This includes Azure Machine Learning, Azure Databricks, and various data storage and processing solutions. For Hyperparameter optimization, Azure ML offers SweepJob. Hyperparameter tuning with a sweep job automates the labor-intensive process of fine-tuning machine learning models by systematically exploring a defined range of hyperparameter values and selecting the best combination for optimal model performance. It involves creating a configuration that specifies the hyperparameter search space, optimization algorithm, and evaluation metric, which is then submitted to a computing environment capable of distributed training and hyperparameter optimization. The sweep job iteratively samples hyperparameters, trains models, evaluates their performance, and updates hyperparameter values based on the results, often using intelligent optimization algorithms. The end result is a set of hyperparameters that maximize model performance, reducing the need for manual trial and error. This approach streamlines the model development process and helps ensure that machine learning models are fine-tuned for optimal performance in real-world applications.

ML PipeLine Deployment: The complete automated pipeline can be deployed and maintained on the cloud via Azure Machine Learning pipelines. The core of a machine learning pipeline is to split a complete machine learning task into a multistep workflow. Each step is a manageable component that can be developed, optimized, configured, and automated individually. Steps are connected through well-defined interfaces. The Azure Machine Learning pipeline service automatically orchestrates all the dependencies between pipeline steps. This modular approach brings two key benefits: Standardize the Machine learning operation (MLOps) practice and support scalable team collaboration, and Training efficiency and cost reduction.

The pipeline via Azure ML Pipelines can be deployed as a batch endpoint. It allows:

To run machine learning pipeline from other platforms out of Azure Machine Learning (for example: custom Java code, Azure DevOps, GitHub Actions, Azure Data Factory). Batch endpoint lets do this easily because it's a REST endpoint and doesn't depend on the language/platform.

To change the logic of your machine learning pipeline without affecting the downstream consumers who use a fixed URI interface.

### Model Transformation for Deployment on Edge Device:

The deployment way as we've brainstormed would be a bit different, normally as we would deploy a (trained) model let's say on the cloud to serve user requests, but in our use case as we plan to deploy it on the device, we plan to deploy the pipeline (the complete ML workflow from data processing to model generation, and training) on the cloud as batch endpoint. The output we would be getting is the best performing model. We can add a step in the same pipeline to minimize the model to be compatible for deployment in ESP 32. This way we could get the compatible model as output from the same running workflow.

As we plan to install the model on edge, and our main focus is on dynamic model generation during install and maintenance, resultantly these two major dimensions guide this choice of our system deployment. The model is an output of a pipeline, a pipeline that receives and loads the data, handles the data thus processes and transforms it, fixes any issue in the data, generates model and thus trains it. The output from that model is a pipeline. A device is very optimized and hardware-resource restricted environment where a strict balance has to be maintained between resource consumption and performance. Thus, majority of the processing load on device can be waived-off by deploying the pipeline on cloud. This way, the complete process og getting and preparing data, training and optimizing the model for deployment in ESP 32 will take place on cloud. The ready model as output will be installed on device. This covers the installation supported by real time model building to be deployed on the edge. In addition to that, cloud platforms such as Azure Machine Learning offers a studio of services to deploy complete Machine Learning workflows in the form of pipelines. Thus, maintenance/update is made possible as it won't affect the underlying number of users accessing the service. The change in single source on cloud will be reflected throughout the user base.

Challenges with Building Models for Edge and Proposed Solution:

The main challenges with current technologies of building edge models is the support for dynamic model generation and robust maintenance. We intend to overcome these hurdles by developing a robust automated pipeline, that is able to handle real time data and model generation. Moreover, it is able to support robust maintenance, as deployment on cloud as a a complete pipeline allows the system team to maintain and update the pipeline without affecting the underlying users. It will also remove the need for changes at the edge level for any updates in the running Machine Learning workflow.

Limited computational resources: Edge devices typically have limited processing power, memory, and storage capacity. This constraint makes it challenging to deploy complex deep learning models that require significant computational resources. As our system's main focus is on dynamic model generation in the installation as well as maintenance phase, thus it is very compute expensive as dynamic model generation involves the problem of optimization over a defined search space. Thus, we intend to solve this problem by deploying the complete pipeline till the model output as a batch endpoint on the cloud.

Data privacy and security: Ensuring data privacy and security while deploying machine learning models on these devices is critical. Implementing security protocols on the edge would put significant load on the constrained processing hardware. Thus, by deploying the Machine Learning workflow on the cloud, significant security measures can be implemented, including custom measures and protocols on top of large number of security options provided by the cloud providers.

Heterogeneity in the Edge Environment: The edge ecosystem can be comprised of diverse deployment environment, our system handles this situation by dynamic model generation that will handles the diverse challenges and variables in the deployment scenario such as pipe diameter variation, external/internal environment variation, and fluid type variation. Edge environments often face changing or evolving tasks and data patterns. A dynamic model generation system can adapt to these changes by generating new models, ensuring that the edge device remains effective and accurate over time.

Handling Major Data Drift: Currently systems mostly focus on same data distribution learning with less focus on major data drift especially in time series problem. The proposed system, equipped with dynamic model building capability handles this issue by dynamically changing with changing data over time thus solving this issue.

Edge-specific data distribution: Edge devices may operate in environments with limited or intermittent connectivity, and local environments. Developing strategies for handling data distribution and synchronization in such scenarios is a challenge. Which our system handles using dynamic modeling and learning.

Transmitting data to the cloud for model inference can be costly in terms of bandwidth and latency. With dynamic model generation, inference can often be performed locally, reducing the need for constant data transfer and minimizing the reliance on cloud resources.

Overall dynamic model generation is a major shift and strong dimension in this project, catering to many issues currently existing in conventional systems. Recent work focuses on data processing and training on the edge by citing the benefit of less latency. But this scenario pre-assumes that the ML workflow is static and set, it does not involve real time model generation, thus such solutions are very data specific. They cannot handle heterogeneous deployment environments and adapt to changing data and needs. Thus, our solution proposes deployment of ML Workflow as Pipeline on the cloud as batch endpoint, and providing dynamic modelling capability to the intelligent edge system.

### 2.4 Data Collection Via Simulation for PipeX

In the processes described above, the data used for training the model 1214 is either captured and then possibly enhanced via synthetic data generation. As explained in Appendix A, the data can also be simulated in whole or in part.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of′ are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A system comprising:
at least one hardware processor; and
one or more software modules that are configured to, when executed by the at least one hardware processor,
receive an input data set, comprising parameters related to fluid viscosity, pipe material, and pipe diameter;
perform data analysis comprising automatically extracting various properties of time series data from the input data set, checking class imbalance in the input data set, and extract time series patterns and trends of the input data set;
perform data preprocessing encode, normalize and handle any missing values in the input data set;
select model hyperparameters and model architecture to develop a model;
perform model training for the model;
evaluate the model after training; and
deploy the model in a device.

2. The system of claim 1, wherein the one or more software modules are further configured to, when executed by the at least one hardware processor, obtain new data after the evaluation and before deploying the model.

3. The system of claim 1, wherein the one or more software modules are further configured to, generating synthetic data when a class imbalance is detected in the input data set.

4. The system of claim 3, further comprising testing the synthetic data for drift, and correcting any drift when detected.

5. The system of claim 4, wherein the synthetic data comprises multivariate time series data based on available input data.

6. The system of claim 3, wherein synthetic data generation is performed using a plurality of GAN channels.
